(19) United States
(12) Patent Application Publication
(10) Pub. No.: US 2012/0103291 A1
(43) Pub. Date: May 3, 2012

(54) ENGINE CONTROL DEVICE FOR WORKING VEHICLE

(76) Inventors: Masahumi Ota, Osaka (JP); Kazuhisa Yokoyama, Osaka (JP); Hiroshi Isobe, Osaka (JP)

(21) Appl. No.: 13/382,850

(22) PCT Filed: May 12, 2010
(86) PCT No.: PCT/JP2010/058024

§ 371 Date: Jan. 6, 2012

(30) Foreign Application Priority Data
Jul. 8, 2009 (JP) 2009-161565

(51) Int. Cl. F02N 11/08

(52) U.S. Cl. 123/179.3

(57) ABSTRACT

An engine control device for a working vehicle in which a start switch starting an engine and a starter relay supplying electric current to a starting motor for assisting the starting of the engine in connection with the start switch are connected to a controller, the controller supplies the starter relay with electricity by the operation of the start switch, and drives the engine along with the driving of the starting motor, wherein the engine control device includes a check mechanism of the starting motor which stops the supply of electricity to the starter relay depending on an electricity supplying time of the starter relay.

### TECHNICAL FIELD

The present invention relates to an engine control device for a working vehicle in which a controller supplies a starter relay with electricity by the operation of a starter switch, whereby a starting motor is driven to start an engine. More specifically, the present invention relates to an engine control device for a working vehicle in which the engine control device is provided with a check mechanism for the starting motor which stops the supply of electricity to the starter relay depending on the time of the supply of electricity to the starter relay.

### BACKGROUND ART

In the past, in an engine control device for a working vehicle such as a tractor, there is an engine starting device in which, when a key switch is operated and electricity is supplied from a battery to an excitation coil of a starter relay, the starter relay is closed, and the engine is started by the rotation of the motor supplied with electricity from the battery via a magnetic switch, and when a key switch is returned after the engine starting, the starter relay is opened, the supply of electricity to the motor is blocked in accordance with the blocking of the supply of electricity to the magnetic switch, and the operation of the starter is stopped (for example, PTL 1). Moreover, in the engine starting device described in PTL 1, there is a technique in which, before the motor of the starter is continuously supplied with electricity due to a defect of the key switch or the like, and a thermal degradation of an external component is generated, the supply of electricity to the starter is blocked, and a warning device notifies that the supply of electricity to the motor is blocked.

Furthermore, there is also an engine control device (PTL 2) in which a seat leaving detector or the like of a worker installed below the sear and a main switch and a cell motor for engine starting, a cell motor starting relay, a fuel cut valve, a solenoid opening the fuel cut valve, a solenoid relay or the like installed below a seat are connected to the controller, the controller automatically stops the engine based on seat leaving information of a worker by the seat leaving detector after the engine starting, thereby preventing the runaway of a structure by an erroneous operation in the state in which a worker leaves the seat, and there is also a technique which makes an engine starting electric circuit a non-operation state (for example, PTL 3) without starting the engine by a safety arousal based on detection information such as a power transmission by a shift detector during engine starting, and notifies the situation to a worker by a warning device.

### CITATION LIST

### Patent Literature

PTL 1: Japanese Unexamined Patent Application Publication No. 2001-207942
PTL 2: Japanese Unexamined Patent Application Publication No. 2004-190636
PTL 3: Japanese Unexamined Patent Application Publication No. 2003-184717

### DISCLOSURE OF INVENTION

### Technical Problem

However, there is a problem in that, in the engine control device for the working vehicle, when starting the engine by operating the key switch, under the circumstances where the engine startability deteriorates (the start-up of the engine deteriorates) at a low temperature or the like, a worker performs the cranking by the continuous driving of the starting motor for a relatively extended time in accordance with the connected key switch operation until the engine is started, whereby the starter motor may cause heating, smoking emission or the like, and the starting motor may be damaged.

Furthermore, there is also a problem in that it is difficult for a worker to discriminate and recognize a warning sound as a warning device for safety arousal during engine starting, and a warning sound as a warning device notifying failure or the like of the device of the vehicle, and there is also a problem in that an electrical circuit constituting the components is complicated, and productivity and maintenance deteriorate.

Furthermore, when operating the start switch by a worker, the controller supplies a glow relay supplying electric current to a glow plug for warming the engine with electric current from a battery by a timer provided in the circuit for a predetermined time. However, since the timer is erroneously operated and failure occurs through a temperature condition or the like, the electric current supplying to the glow relay is likely to be excessive or deficient, and a normal starting operation of the engine may not be performed. Moreover, in the control circuit in the engine control device of the related art, since a power relay such as the solenoid relay and the glow relay is provided outside the controller, there is a problem in that the control circuit configuration is complicated and workability such as maintenance deteriorates.

Thus, an object of the present invention is to prevent the damage of the starting motor and to enable a smooth engine starting. Furthermore, an easier safety mechanism is provided by allowing the notification by the warning device for safety arousal to a worker during engine starting and during driving to be discriminated, and a control circuit of a simple configuration is included by improving control accuracy. Thus, an engine control device for a working vehicle is provided in which workability and safety are improved, a circuit configuration thereof is simplified, and maintenance is improved.

### Solution to Problem

For this reason, according to the invention described in Claim 1, there is provided an engine control device for a working vehicle in which a start switch performing a starting operation of an engine and a starter relay supplying electric current to a starting solenoid driving a starting motor for starting an engine in connection with the start switch are connected to a controller, the controller supplies the starter relay with electricity by outputting an engine starting instruction to the starter relay by the operation of the start switch, to supply the start-up solenoid with electric current, and drives the engine along with the rotation of the starting motor, characterized in that the engine control device includes a check mechanism of the starting motor which stops the supply of electricity to the starter relay depending on an electricity supplying time of the starter relay.

According to the invention described in Claim 2, in the engine control device for the working vehicle described in Claim 1, characterized in that the check mechanism is built in the controller, and the controller performs switching of electricity supplying turn on and off to the starter relay at a freely variable predetermined time or time interval.

According to the invention described in Claim 3, in the engine control device for the working vehicle described in Claim 1, characterized in that a glow relay supplying the electric current to a glow plug as a preheating device used in the engine ignition is connected to the controller.

According to the invention described in Claim 4, in the engine control device for the working vehicle described in Claim 1, characterized in that a solenoid relay supplying electric current to an engine stop solenoid further driving or stopping the engine, a shift detector detecting a shift position of a running system power transmission member, a PTO detector detecting a power transmission situation to a PTO shaft driving a working machine, and a seat detector detecting a seating situation of a worker to a seat installed in a vehicle steering section are also connected to the controller, and output to the engine stop solenoid and a safety mechanism including a warning device are connected to one output port of the controller.

According to the invention described in Claim 5, in the engine control device for the working vehicle described in Claims 1 and 4, characterized in that, when a safety arousal mode is obtained in which one or more of the detection information of a power non-transmission to the driving system by the shift detector, the power non-transmission to the PTO shaft by the PTO detector, and the seat seating of a worker by the seat detector is not attained when driving the engine, the controller stops the supply of electricity to the solenoid relay, stops the electric current supplying to the engine stop solenoid, and operates the warning device.

According to the invention described in Claim 6, in the engine control device for the working vehicle described in Claims 1 and 4, characterized in that, when the safety arousal mode is obtained during engine starting, the controller stops the supply of electricity to the starter relay, checks the start-up of the engine, stops the electric current supplying to the engine stop solenoid, and operates the warning device.

According to the invention described in Claim 7, in the engine control device for the working vehicle described in Claim 1, characterized in that the engine control device includes a transfer contact relay at the outside of the controller.

According to the invention described in Claim 8, in the engine control device for the working vehicle described in Claims 1, 4, and 5, the controller excites the glow relay and the solenoid relay for a certain time, by the operation of the start switch.

According to the invention described in Claim 9, in the engine control device for the working vehicle described in Claims 1, 4, 5, and 8, characterized in that the controller is equipped with the glow relay, and the solenoid relay.

### Advantageous Effects of Invention

According to the invention described in Claim 1, there is provided an engine control device for a working vehicle in which a start switch starting an engine, and a starter relay supplying electric current to a starting motor for performing a starting assistance of an engine in connection with the start switch are connected to a controller, the controller supplies the starter relay with electricity by the operation of the start switch, and starts the engine along with the driving of the starting motor, wherein the engine control device includes a check mechanism of the starting motor which stops the supply of electricity to the starter relay depending on the supply of electricity time of the starrer relay. Thus, under a situation where an operating method of a key switch and engine startability deteriorate such as at a low temperature, when the supply of electricity to the starter relay connected to the key switch exceeds a predetermined time, the controller blocks the supply of electricity to the starter relay by the check mechanism. Thus, it is possible to prevent a continuous unnecessary long driving of the starting motor, prevent the failure and the heating of the starting motor, and extend the product life of the starting motor. Accordingly, it is possible to provide an engine control device for a working vehicle having improved workability and safety.

According to the invention described in Claim 2, the check mechanism is built in the controller, and the controller performs switching of electricity supplying turn on and off to the starter relay at a variable predetermined time or time interval. Thus, the circuit configuration can be simplified, the supply of electricity time and the supply of electricity interval to the starter relay are arbitrarily set, the controller and the check mechanism minutely turns the supply of electricity time to the starter relay ON/OFF along with the operation of the start switch for a predetermined time, the continuous electric current supplying to the starter solenoid is prevented, and the continuous driving of the starting motor is prevented, whereby the driving load of the starting motor can be reduced. Accordingly, it is possible to provide an engine control device for a working vehicle having improved workability and productivity.

According to the invention described in Claim 3, a glow relay supplying the electric current to a glow plug as a preheating device used in the engine ignition is connected to the controller. Thus, it is possible to excite the glow relay along with the operation of the key switch, improve the engine startability when operating the key switch again, shorten the driving time of the starting motor, and prevent the abrasion and the damage of the starting motor. Accordingly, it is possible to provide an engine control device for a working vehicle having improved workability and productivity.

According to the invention described in Claim 4, a solenoid relay supplying electric current to an engine stop solenoid further driving or stopping the engine, a shift detector detecting a shift position of a running system power transmission member, a PTO detector detecting a power transmission situation to a PTO shaft driving a working machine, and a seat detector detecting a seating situation of a worker to a seat installed in a vehicle steering section are also connected to the controller, and output to the engine stop solenoid and a safety mechanism including a warning device are connected to one output port of the controller. Thus, the solenoid relay (an engine stop relay) and the warning device entering the reversal state of presence and absence of the output are connected to the one output port in the controller. Accordingly, it is possible to prevent the complicated configuration of the circuit having the output ports independent from each other like the related art, simplify the circuit configuration, and reduce the burden to be applied to the controller. Thus, it is possible to provide an engine control device for a working vehicle having improved workability and safety.

According to the invention described in Claim 5, when a safety arousal mode is obtained in which one or more of the detection information of a power non-transmission to the driving system by the shift detector, the power non-transmission to the PTO shaft by the PTO detector, and the seat seating of a worker by the seat detector during engine driving is not attained, the controller stops the supply of electricity to the solenoid relay, stops the electric current supplying to the engine stop solenoid, and operates the warning device. Thus, runaway due to the erroneous operation of the vehicle can be prevented, and a worker knows that the driving stop of the engine is in the safety arousal mode by the operation of the warning device, and it is possible to safely restart and drive the engine. Accordingly, it is possible to provide an engine control device for a working vehicle having improved operability and safety.

According to the invention described in Claim 6, when the safety arousal mode is obtained during engine starting, the controller stops the supply of electricity to the starter relay, checks the start-up of the engine, stops the electric current supplying to the engine stop solenoid, and operates the warning device. Thus, the warning device notifies a worker that the engine is not started and driven by the safety arousal mode of the vehicle during starting of the engine, whereby the safety confirmation can reliably be performed before the start-up of the engine. Furthermore, there is no need to install a separate device for the notification of the safety arousal during the engine starting, the warning device mentioned above can be combined, and the circuit configuration can be simplified. Accordingly, it is possible to provide an engine control device for a working vehicle having improved workability.

According to the invention described in Claim 7, the engine control device includes a transfer contact relay at the outside of the controller. Thus, even in a case where the number of output port of the controller is limited, and in a case where an electric current value required for the circuit controlling the driving and the stop of the engine is increased and it is difficult to place a contact of a high capacity in the controller, it is possible to notify that the engine is not started and driven in the safety arousal mode of the vehicle by a minimum device connection to the controller, and the circuit configuration thereof can be simplified. Accordingly, it is possible to provide an engine control device for a working vehicle having improved workability.

According to the invention described in Claim 8, since the controller excites the glow relay and the solenoid relay by the operation of the start switch for a certain time, when starting the engine, the engine is preheated via the glow plug by the glow relay excited in advance. Thus, the engine is easily ignited by the operation of the starting motor, the startability of the engine is improved, and engine is supplied with fuel by the electric current directly supplied from the solenoid relay to the engine stop solenoid, by the solenoid relay excited in advance, and thus, the engine is stably driven. Furthermore, since the controller controls the excitation time to the glow relay, compared to a case where a separate timer or the like is provided in the circuit of the engine control device like the related art, it is possible to always and accurately excite the glow relay by a predetermined time without depending on a condition change such as a temperature condition, and the circuit configuration can be simplified. Accordingly, it is possible to provide an engine control device for a working vehicle having improved workability.

According to the invention described in Claim 9, since the controller is equipped with the glow relay, and the solenoid relay, the circuit of the engine control device 31 can be simply configured without placing the power relay such as the glow relay and the solenoid relay at the outside of the controller like the related art. Thus, it is possible to provide an engine control device for a working vehicle having improved maintenance property.

### BRIEF DESCRIPTION OF DRAWINGS

FIG. 1 is a left side view of a wheel type tractor that shows an example of a working vehicle including an engine control device of the present invention.

FIG. 2 is a perspective view in which a steering section of the tractor is viewed from the back.

FIG. 3 is an electric circuit diagram of the engine control device.

FIG. 4 is a block control diagram of the engine control device.

FIG. 5 is an operation diagram of a start switch and a starter relay.

FIG. 6 is an electric circuit diagram of the engine control device including a safety mechanism.

FIG. 7 is a block control diagram of the engine control device.

FIG. 8 is an operation diagram of the safety mechanism.

FIG. 9 is an electric circuit diagram of the engine control device provided with an engine stop relay.

FIG. 10 is an operation diagram of the safety mechanism when the engine is started.

FIG. 11 is an operation diagram of the safety mechanism which intermittently operates a warning device.

FIG. 12 is an operation diagram of the safety mechanism which operates the warning device for a predetermined time.

FIG. 13 is an electric circuit diagram of the engine control device of a case where the control of the driving or the stop of the engine is not required in a safety arousal mode.

FIG. 14 is an electric circuit diagram of the engine control device including a controller equipped with a power relay.

### REFERENCES SIGNS LIST

6 engine
14 key switch
14a main switch
14b start switch
31, 31a, 31b, 31c, 31d engine control device
32, 32′ controller
43 glow relay
45 solenoid relay
46 engine stop solenoid
47 starter relay
K check mechanism
M starting motor
S safety arousal mode
T1, T2, T3 transfer contact
k warning mechanism

### DESCRIPTION OF EMBODIMENTS

Hereinafter, the best mode for carrying out the present invention will be described in detail while referring to the drawings.

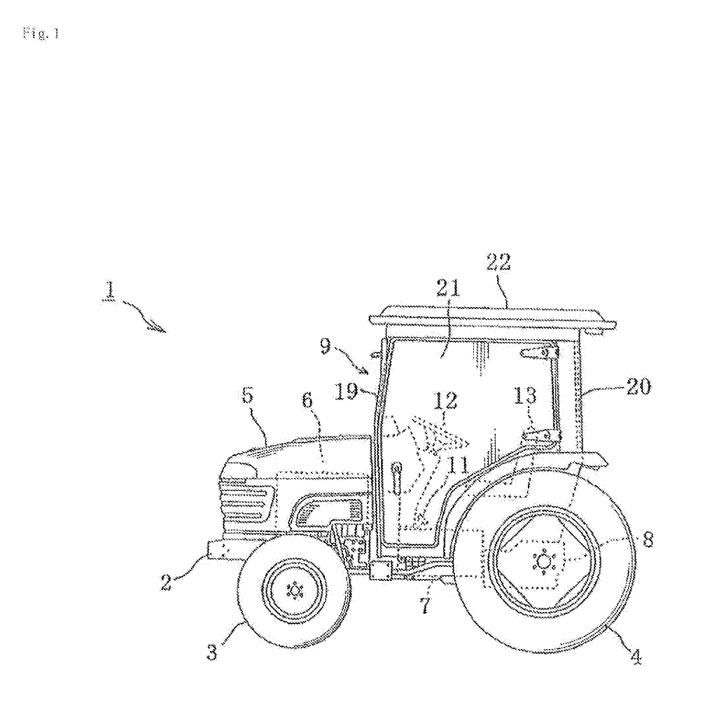

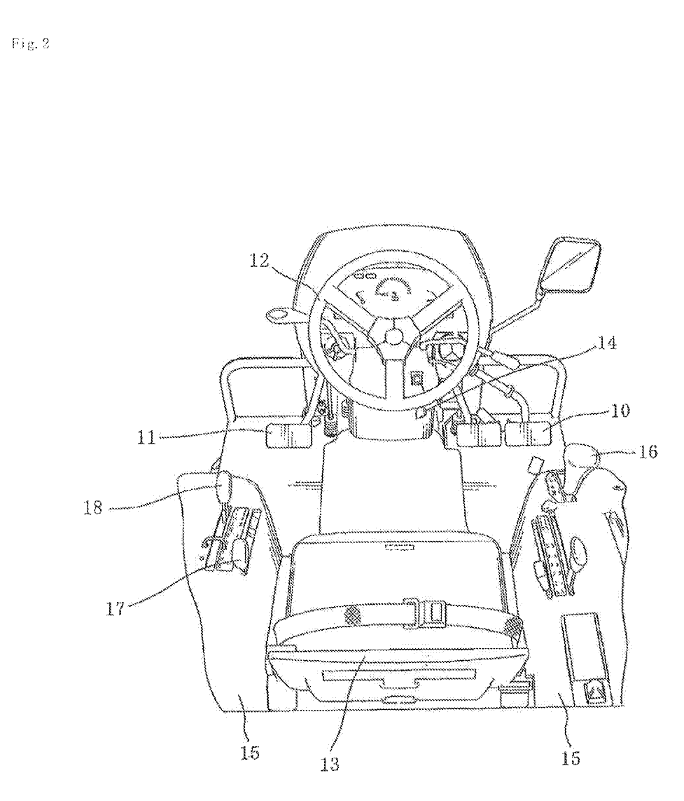

FIG. 1 is a left side diagram of a wheel type tractor that shows an example of a working vehicle including an engine control device of the present invention. FIG. 2 is a perspective view in which a steering section of the tractor is viewed from the back. In addition, the tractor as the working vehicle shown in FIG. 1 is not limited to a wheel type tractor of a cabin specification, but may be a ROPS specification, a crawler type or the like. Furthermore, the working vehicle is not limited to the tractor, but may be a working vehicle including an engine control device such as a combiner, a snowplow, and a construction working vehicle.

As shown in FIG. 1, the tractor 1, which is the working vehicle of the present example, includes a front wheel 3 and a rear wheel 4 before and after a body frame 2, forms a bonnet 5 above the front wheel 3, an engine 6 as a motor member is placed at the inside thereof, and a clutch housing 7 is placed behind the engine 6. Furthermore, a mission case 8 is disposed behind the clutch housing 7, and power from the engine 6 is transmitted to the front wheel 3 and the rear wheel 4. Moreover, a cabin 9 with a front glass 19, a rear glass 20, a door 21, a roof 22 or the like mounted at an outer periphery thereof, respectively, is provided on the body frame 2 continuously to the rear section of the bonnet 5.

Next, as shown in FIG. 2, in the cabin 9, as a steering section of the vehicle, operation pedals such as a brake pedal 10 and a clutch pedal 11, a steering handle 12, a seat 13 or the like are provided. Furthermore, in a suitable position of a steering column near the steering handle 12, a key switch 14 is provided.

Moreover, in left and right fenders 15 provided at both sides of the seat 13, for example, various operation pedals such as a main gearshift lever 16, a sub gearshift lever 17, and a PTO gearshift lever 18 are provided. In addition, the tractor 1 is not limited to the cabin specification mentioned above, but ROPS specification may be adopted.

Moreover, power from the engine 6 is transmitted from a PTO shaft (not shown) projected from the mission case 8 via a hydraulic case (not shown). In the vehicle rear, power is able to drive a rear working machine (not shown) mounted via a working machine mounting device such as a universal joint and a three points rink type. In the vehicle front, a front working machine mounted via a pair of left and right hitches (not shown) installed in the front of the body is driven.

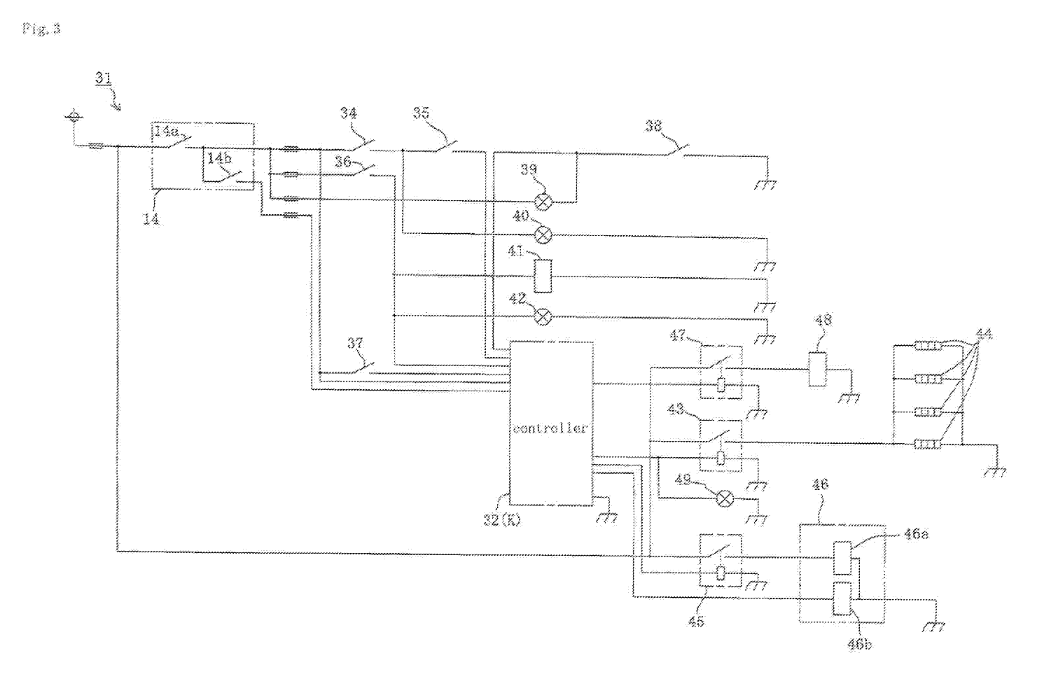

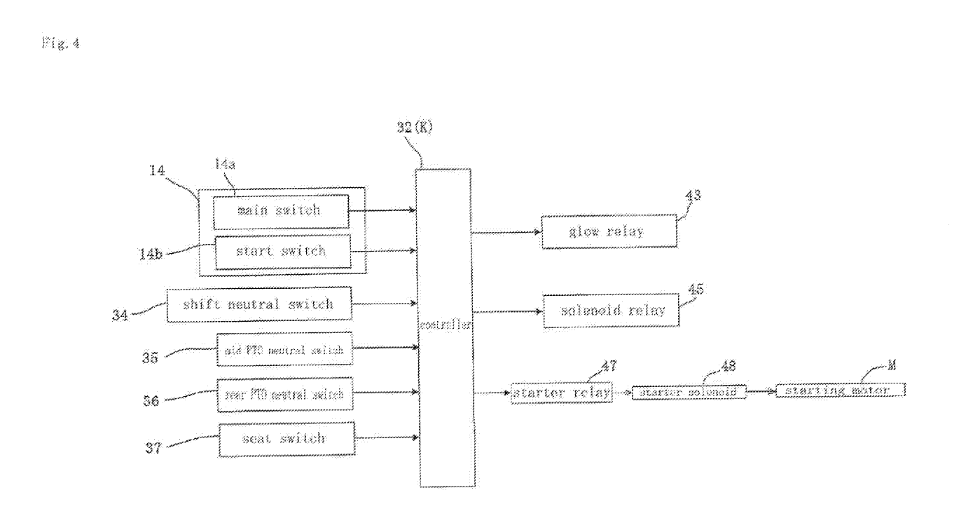

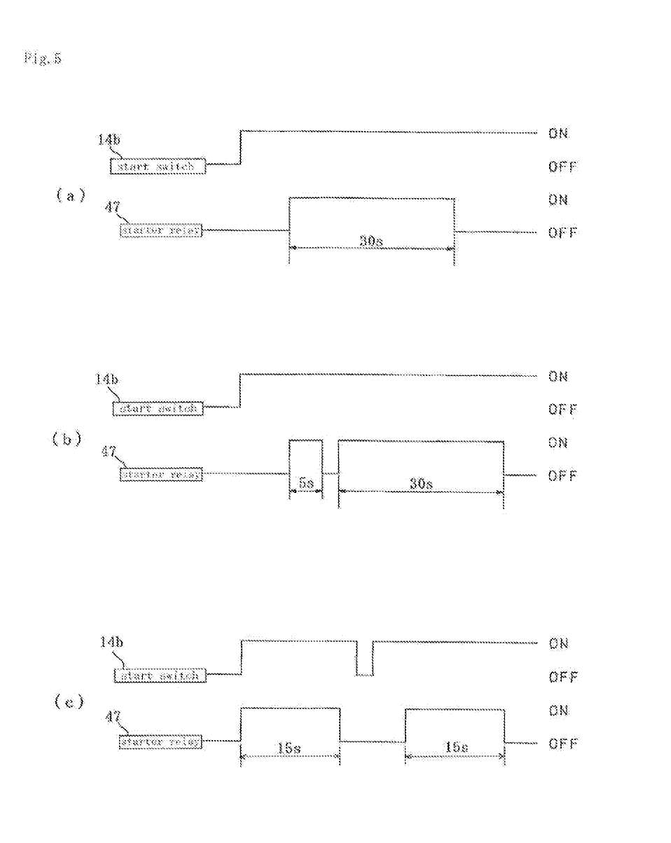

Next, a specific configuration of the engine control device for the working vehicle, which is a characteristic of the present invention, will be described. FIG. 3 is an electric circuit diagram of the engine control device, FIG. 4 is a block control diagram of the engine control device, FIG. 5 is an operation diagram of a start switch and a starter relay.

As shown in FIG. 3, in the engine control device 31 including the controller 32, firstly, as an input side of the controller 31, the key switch 14, a shift neutral switch 34 (a shift detector) detecting a neutral position (a shift position of a running system is in a non-transmission state) of the main gearshift lever 15 which is a vehicle running system, a mid PTO neutral switch 35 (a PTO detector) detecting that the power transmission to a mid PTO (not shown) included near a vehicle center is in a neutral (the non-transmission) state, a rear PTP neutral switch 36 (PTO detector) connecting a hydraulic clutch so as to transmit power to a PTO shaft (not shown) included in the vehicle rear, and a seat switch 37 (a seat detector) detecting the seating of a worker on the seat 13 are connected to the controller 32.

Furthermore, a parking switch 38 detecting the operation of a parking brake (now shown) of the vehicle is also connected to the controller 32. In addition, reference numeral 39 is a lamp notifying a driver that the parking brake is applied, reference numeral 40 is a lamp notifying a driver that the main gearshift lever 15 is in a neutral state, reference numeral 41 is a PTO solenoid, and a reference numeral 42 is a lamp notifying a driver that the PTO shaft is rotated by the power transmission state.

The key switch 14 is connected to a battery (not shown), and the key switch 14 is constituted by a main switch 14a which turns the whole power sources in the circuit on and off, and a start switch 14b which starts the engine 6 via the driving of the starting motor M shown in FIG. 4.

In addition, the shift neutral switch 34, the mid PTO neutral switch 35, the PTO neutral switch 36, and the seat switch 37 mentioned above are known techniques described in, for example, Japanese Unexamined Patent Application Publication No. 2007-230417, Japanese Unexamined Patent Application Publication No. 2004-190636 or the like, and thus the detailed descriptions thereof will be omitted.

Next, as the output side of the controller 32, a glow relay 43, which is a power relay supplying a glow plug 44 as a preheating device of the engine 6 with electric current, and a solenoid relay 45, which is a power relay supplying electric power to an engine stop solenoid 46 for supplying fuel to the engine 6, are connected to the controller 32. Furthermore, a starter relay 47 supplying electric current to a starter solenoid 48 for exciting a contact in the starting motor M is also connected to the controller 32.

In addition, reference numeral 49 is a lamp which notifies a worker that the engine 6 is preheated for starting the engine 6.

The engine stop solenoid 46 is constituted by a suction section 46a which suctions a lot of electric current obtained from the solenoid relay 45, and a holding section 46b which is enable to supply the engine 6 with fuel by holding the sucked electric current.

Moreover, in the controller 32 in the engine control device 31 of the present invention, a check mechanism K is provided which checks the driving of the starting motor M. The check mechanism K is constituted by the start switch 14b, the controller 32, and the starter relay 47, and controls the supply of electricity of the starter relay 47 by the controller 32.

Namely, the controller 32 is provided with a timer function including the check mechanism K which performs the switching of the supply of electricity turn-off (ON/OFF) to the starter relay 47 depending on the continuous operation time (a continuous input time) of the start switch 14b, and the timer function can be changed at an arbitrary setting time from the outside of the controller 32.

Thus, by the configuration in which the controller 32 is provided with the check mechanism K and the timer function, there is no need to connect a separate check mechanism and a timer to the outside of the controller 32 in the electric circuit constituting the engine control device 31, and it is possible to improve the maintenance property by simplifying the electric circuit constituting the engine control device 31 without generating defects and faults due to the temperature condition or the like.

In the present example, the setting time as the timer function in the controller 32 is 30 seconds. This means that, after the controller 32 supplies the starter relay 47 with electricity for 30 seconds by the operation of the start switch 14b, the controller 32 blocks the supply of electricity to the starter relay 47 by the check mechanism K. The setting time is not limited to the 30 seconds, but the time can be suitably set depending on the car model and the size of a working vehicle, a working environment or the like.

Moreover, as shown in FIG. 4, in order that a worker starts and drives the engine 6 of the vehicle, when operating the start switch 14b via the main switch 14a of the key switch 14, the controller 32 supplies the glow real 43 with electric current obtained from the battery for a certain time such as, for example, 15 seconds (not limited) by operating the start switch 14b, to excite the glow relay 43. Furthermore, the controller 32 also supplies the solenoid relay 45 with electric current obtained from the battery for a certain time such as, for example, 1 second (not limited) to excite the solenoid relay 45.

Through such a configuration, when starting the engine 6, since the engine 6 is preheated via the glow plug 46 by the glow relay 43 excited in advance, the engine 6 is easily ignited by the operation of the starting motor M, and thus, the startability of the engine 6 is improved. Furthermore, by the solenoid relay 45 excited in advance, simultaneously with the start-up of the engine 6, by electric current directly supplied from the solenoid relay 45 to the engine stop solenoid 46, the engine 6 is supplied with fuel, and thus, the engine 6 is stably driven. Furthermore, since the controller 32 controls the excitation time to the glow relay 43, compared to the case of providing a separate timer or the like in the circuit of the engine control device like the related art, it is possible to always and accurately excite the glow relay 43 by a predetermined time, without depending on the condition change such as the temperature condition, and the circuit configuration can be simplified.

Next, when the whole detection information of the indication, in which the main gearshift lever 15 by the detection of the shift neutral switch 34 is in the neutral position, the power non-transmission state to the PTO shaft by the detection of the mid PTO neutral switch 35 and the rear PTO neutral switch 36, and the seating state of the seat 13 of a worker by the detection of the seat switch 37, is input to the controller 32, the controller 32 supplies the starter relay 47 with electricity, and supplies the starter solenoid 48 with electric current, whereby the starting motor M is operated, and the engine 6 is started.

Herein, for example, when a vehicle is under a low temperature environment, if starter solenoid 48 is not operated to drive the starting motor M for an extended time, by operating the start switch 14b for a relatively extended time, and supplying the starter relay 47 with electricity for an extended time, a situation may occur where engine 6 is not started and the startability of the engine 6 deteriorates (start-up of the engine 6 deteriorates).

In this case, as shown in FIG. 5(a), if the supply of electricity time of the starter relay 47 is within 30 seconds by the continuous operation of the start switch 14b, the controller 32 normally supplies the starter relay 47 with electric current, and the engine 6 is started by the driving of the starting motor M due to the operation of the starter solenoid 48 by electric current obtained from the starter relay 47. However, at that time, until a worker returns the engine key to an open position of the main switch 14a along with the start-up of the engine 6, or when the operation time of the start switch 14b is within 30 seconds even if the engine 6 is not started, the controller 32 continues to supply the starter relay 47 with electric current.

As a consequence, if the supply of electricity time of the starter relay 47 is within 30 seconds, the starter relay 48 is operated by the supply of electric current from the starter relay 47, whereby the starting motor M can be driven. In addition, when the engine 6 is started within 30 seconds when the starter relay 47 is supplied with electricity, the driving of the starting motor M is stopped, and thus, it is possible to prevent an unnecessary driving of the starting motor M.

However, when the supply of electricity time of the starter relay 47 exceeds 30 seconds, the check mechanism K is operated, and the controller 32 stops the supply of electric current to the starter relay 47.

As a consequence, when the supply of electricity of the starter relay 47 becomes an extended electricity supplying time exceeding 30 seconds, electric current is not supplied from the starter relay 47 to the starter solenoid 48, and thus, the starter solenoid 48 is not operated, and thereby stopping the driving of the starting motor M.

Through such a configuration, in the situation where the startability of the engine 6 deteriorates at a low temperature or the like, until starting the engine 6, along with the operation of the key switch 14 of an extended time, even when the starter relay 47 is supplied with electricity of an extended time, the supply of electricity to the starter relay 47 is blocked at a predetermined time by the check mechanism K of the controller 32. Thus, it is possible to prevent a continuous and unnecessary long driving of the starting motor M, prevent the damage of the starting motor M, prevent heating and smoke emission of the starting motor M, and increase stability.

Furthermore, the check mechanism K can perform the supply of electricity turn-on and off of the starter relay 47 at a preset certain time and a time interval. In this case, for example, as shown in FIG. 5(b), when the start switch 14b is turned ON (input), the controller 32 firstly changes the supply of electricity to the starter relay 47 from an OFF (disconnection) state to an ON (connection) state by five minutes, and then, turns the same OFF by the check mechanism K for 1 second. After that, the controller 32 can set a configuration, which turns the supply of electricity ON of the starter relay 47 for 30 seconds again, and then, turns the same OFF by the check mechanism K, on the check mechanism K of the controller 32.

In addition, when the engine 6 is started via the starting motor M in initial 5 seconds and 30 seconds after that in the ON state of the starter relay 47, at a point of time when the engine 6 is started, the supply of electricity to the starter relay 47 is blocked.

Furthermore, for example, as shown in FIG. 5(c), when the start switch 14b is turned ON, the controller 32 firstly changes the supply of electricity to the starter relay 47 from the OFF state to the ON state for 15 seconds, and then, turns the same OFF by the check mechanism K. Moreover, at that time, by the re-input of the start switch 14b, the controller 32 can set a configuration, which changes the supply of electricity to the starter relay 47 from the OFF state to ON state again for 15 seconds, and then, turns the same OFF by the check mechanism K, on the check mechanism K of the controller 32.

Moreover, as mentioned above, by the On operation of the start switch 14b, the controller 32 can be configured so that the pattern turning the supply of electricity to the starter relay 47 On for 15 seconds is repeatedly performed until the engine 6 is started via the driving of the starting motor M.

Through such a configuration, the controller 32 and the check mechanism K minutely turn the supply of electricity time to the starter relay 47 due to the operation of the start switch 14b ON for a predetermined time, to prevent the continuous electric current supplying to the starter solenoid 48, and prevent the continuous driving of the starting motor M, whereby it is possible to reduce the driving load to the starting motor M. In addition, the supply of electricity time and the supply of electricity interval to the starter relay 47 are an example mentioned above, and can suitably be set.

Moreover, as mentioned above, whenever the start switch 14b is operated, the controller 32 supplies the glow relay 43 with electric current obtained from the battery, for example, for a certain time such as 15 seconds (not limited), and excites the glow relay 43 in advance. Thus, the engine 6 is preheated by the glow relay 43 via the glow plug 44.

Through such a configuration, whenever the start switch 14b is operated, the glow relay 43 is excited. Thus, the startability of the engine 6 is improved when starting or restarting the start switch 14b, and the driving time of the starting motor M can be shortened. Consequently, it is possible to prevent abrasion and damage of the starting motor M.

Furthermore, when operating the main switch 14a, the excitation time of the glow relay 43 is about 15 seconds in the example of the present invention. Thus, it is possible to supply the electric current to the glow relay 43 to a minimum extent required for the preheating of the engine 6, and an unnecessary waste of electric current can be suppressed.

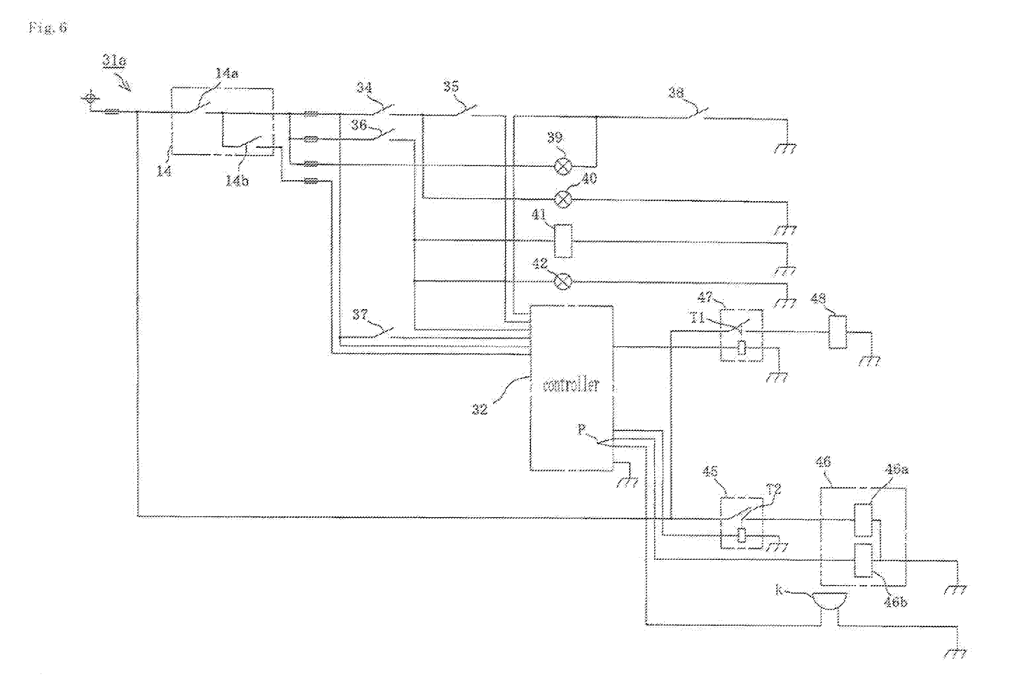

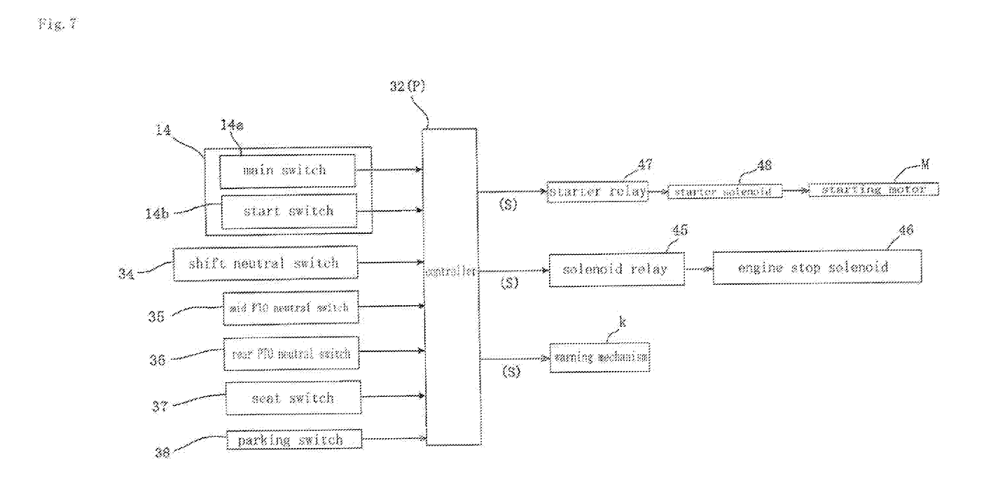

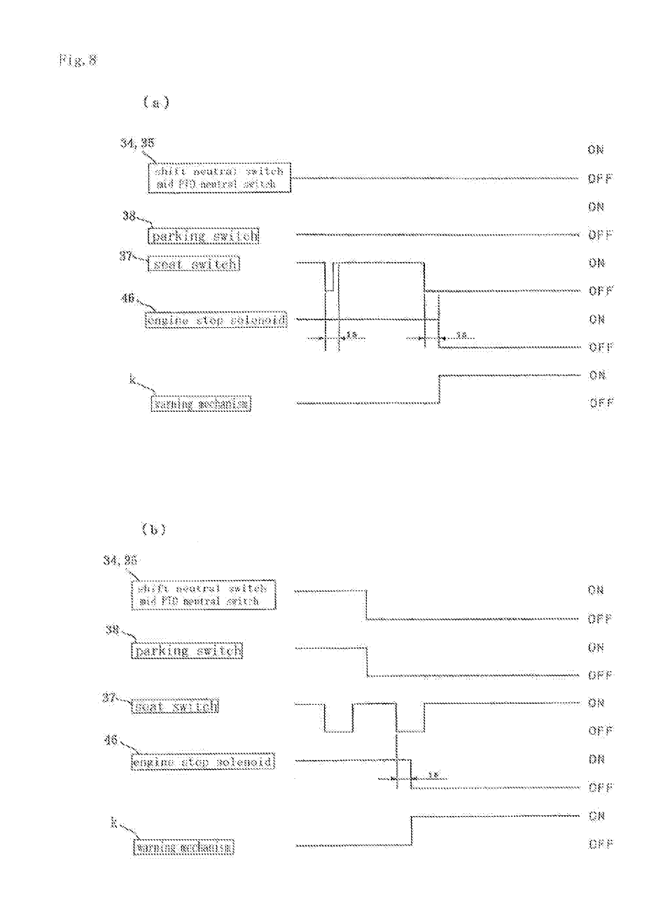

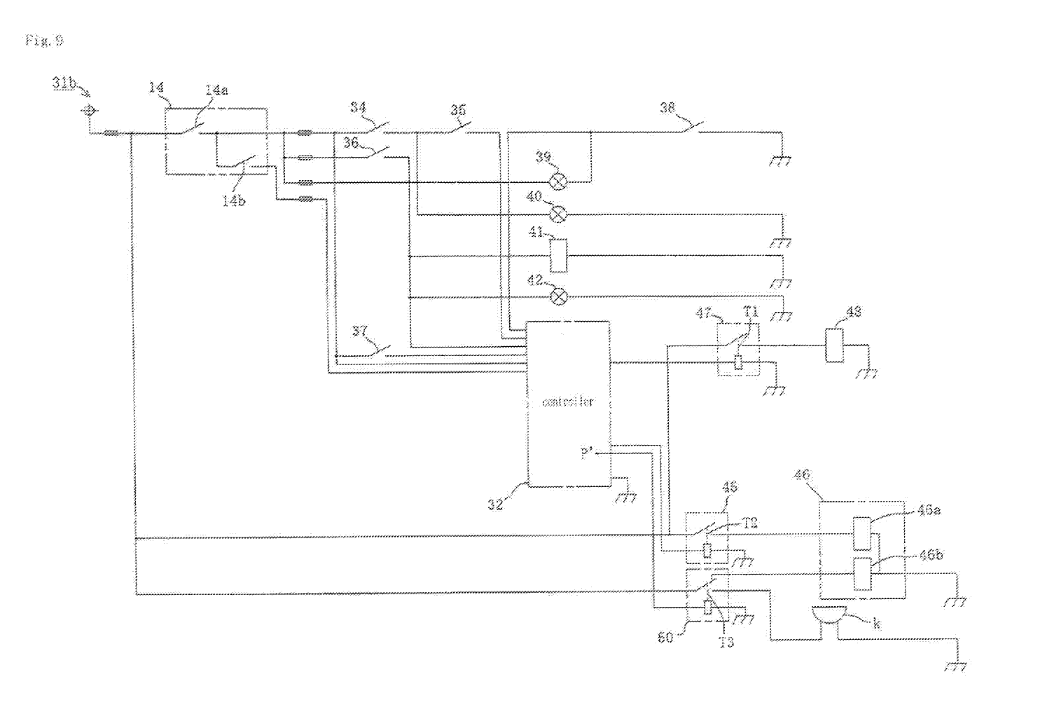

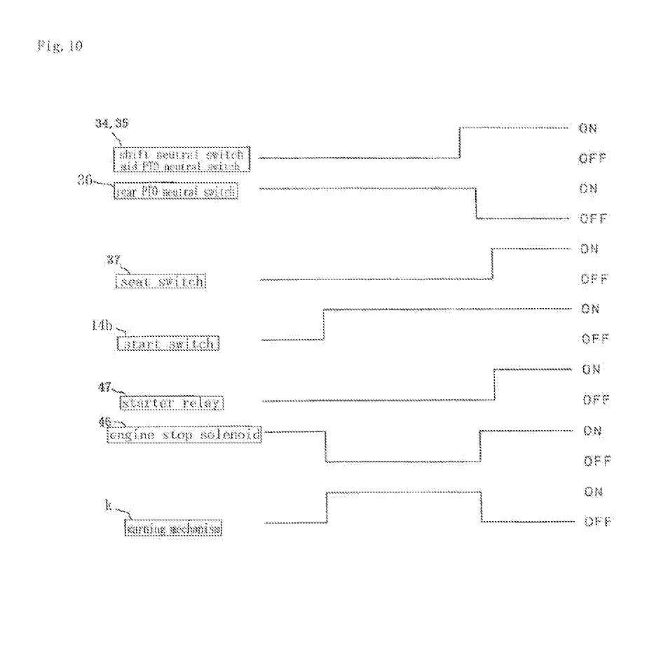

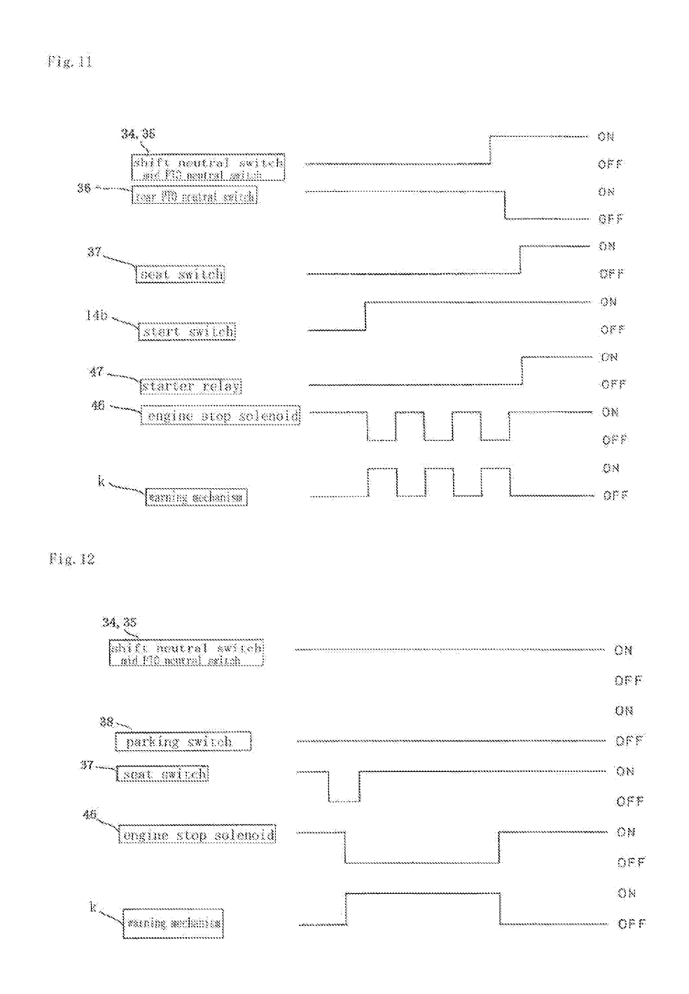

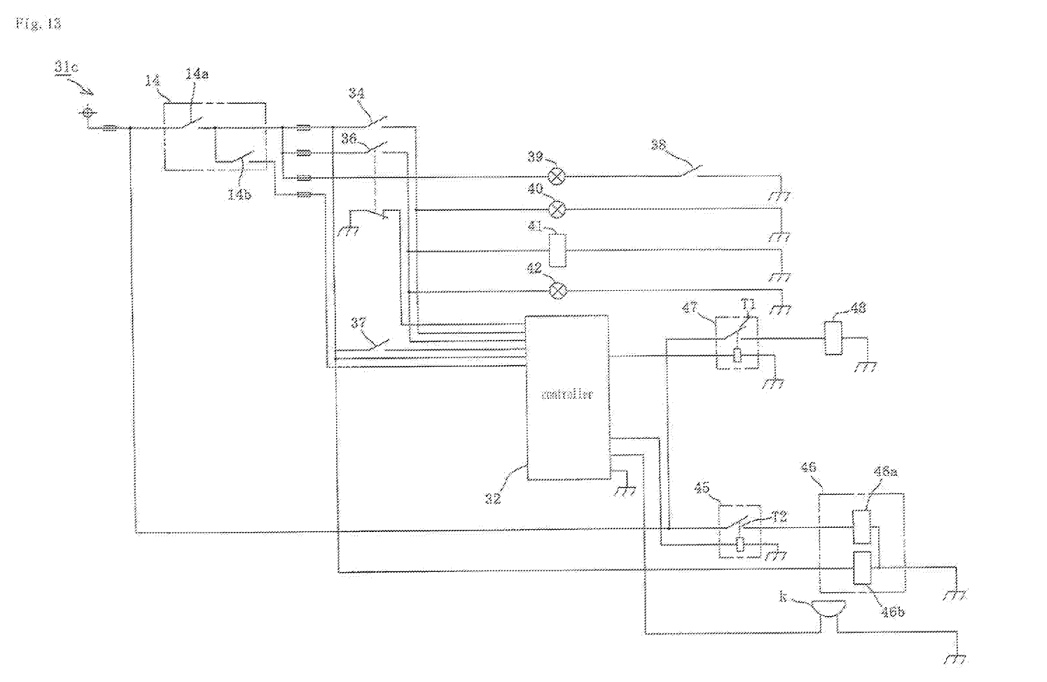

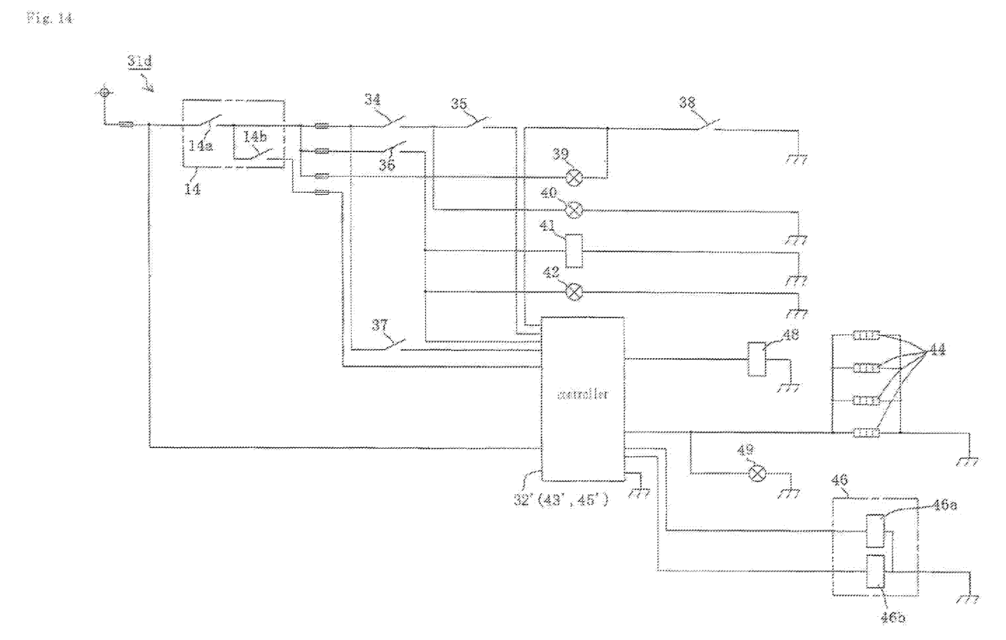

The engine control device of the present invention can include the safety mechanism. FIG. 6 is an electric circuit diagram of the engine control device including the safety mechanism. FIG. 7 is a block control diagram of the engine control device. FIG. 8 is an operation diagram of the safety mechanism. FIG. 9 is an electric circuit diagram of the engine control device provided with an engine stop relay. FIG. 10 is an operation diagram of the safety mechanism when the engine is started. FIG. 11 is an operation diagram of the safety mechanism which intermittently operates the warning device. FIG. 12 is an operation diagram of the safety mechanism which operates the warning device for a predetermined time. FIG. 13 is an electric circuit diagram of the engine control device of a case where the control of the driving or the stop of the engine is not required in a safety arousal mode.

As shown in FIG. 6, in the engine control device 31a, as the output side of the controller 32, the starter relay 47 provided with the transfer contact T1 supplying electric current to the starter solenoid 48 for exciting the contact in the starting motor M, and the solenoid relay 45 provided with the transfer contact T2, which is a power relay supplying electric current to and the engine stop solenoid 46 for supplying the engine 6 with fuel, are connected to the controller 32. In addition, the same reference numerals of the input side of the controller 32 or the like are the same configurations as those of FIG. 3.

Moreover, the warning device k such as the warning buzzer as the safety mechanism is connected to the controller 32. In addition, it is preferable that the warning device k notify a worker of the safety arousal described below by the buzzer sound, but a suitable method such as a warning voice and a warning lamp may be used in addition to the warning buzzer.

Moreover, in the engine control device 31a of the present invention, the solenoid relay 45 including the transfer contact T2 and the warning device k are connected to one output port P in the controller 32.

Herein, as shown in FIG. 7, since a worker starts and drives the engine 6 of the vehicle, when a worker operates the start switch 14b via the main switch 14a of the key switch 14, information operated by the start switch 14b is input to the controller 32.

In addition, the controller 32 may supply the solenoid relay 45 with electricity, for example, for 1 second by the operation of the main switch 14a, and may supply the solenoid relay 45 with electricity for a further 1 second by the operation of the start switch 14b.

Next, when the whole detection information of the indication that the main gearshift lever 15 by the detection of the shift neutral switch 34 is in the neutral position, the power non-transmission state to the PTO shaft by the detection of the mid PTO neutral switch 35 and the rear PTO neutral switch 36, and the seating state of a worker to the seat 13 by the detection of the seat switch 37 is input to the controller 32, the controller 32 supplies the starter relay 47 with electricity to supply the starter solenoid 48 with electric current, whereby the starting motor M is operated and the engine 6 is started.

Moreover, the controller 32 supplies the solenoid relay 45 with electricity to supply the engine stop solenoid 46 with electric current, whereby the engine 6 is supplied with fuel and the engine 6 enters the start-up state.

At this time, for example, as shown in FIGS. 8A, and 8B, when the seating of a worker to the seat 13 by the detection of the seat switch 37 is not detected, if the time when the seating is not detected is, for example, within 1 second, in the output port P, the controller 32 supplies the solenoid relay 45 with electricity with respect to the transfer contact T2 of the solenoid relay 45 to supply the engine stop solenoid 46 with electric current, by an off-delay circuit (not shown) provided in the seat switch 37 in advance, performs the driving output of the engine 6 (continues to drive the engine 6), and does not operate the warning device k.

However, if the seating of a worker to the seat 13 is not detected exceeding one second by the seat switch 37, as the safety arousal mode S, in the output port P, the controller 32 blocks the supply of electricity to the solenoid relay 45 so as not to supply the electric current to the engine stop solenoid 46 with respect to the transfer contact T2 of the solenoid relay 45. Consequently, the controller 32 stops the driving output to the engine 6 (the engine 6 is stopped) and operates the warning device k, thereby notifying a worker of the safety arousal mode S by the warning buzzer or the like.

In addition, in addition to the state in which the seating of a worker to the seat 13 is not detected (non-seating) by the seat switch 37 mentioned above, the safety arousal mode S sets a state in which one or more or all information, for example, a state, in which the neutral position of the main gearshift lever by the shift neutral switch 34 is not detected (the power transmissions state to the driving system) and a state, in which the power non-transmission to the PTO shaft by the mid and rear PTO neutral switch 35 is not detected (the power transmission to the PTO shaft), are not transmitted to the controller 32. Then, the safety arousal mode S stops the engine 6 during driving, operates the warning device k, and notifies a worker of the safety arousal mode S by the warning device k such as the warning buzzer. In addition, the detection information of the parking switch 38 can also be added to the safety arousal mode S.

Furthermore, as shown in FIG. 9, the control circuit of the output side in the controller 32 can also be the engine control device 31b in which the warning device k is connected to an engine stop relay 50 including the transfer contact T3 connected to an output port P′ of the controller 32.

Moreover, as mentioned above, by the configuration of the control circuit, when the safety arousal mode S is set during driving of the engine 6, the controller 32 blocks the supply of electricity to the solenoid relay 45 and stops the electric current supplying to the engine stop solenoid 46 via the engine stop relay 50, whereby the driving of the engine 6 is stopped, the warning device k is operated, and the warning device k such as the warning buzzer notifies a worker of the safety arousal mode S.

Through such a configuration, when setting the safety arousal mode S during driving of the engine 6, the controller 32 stops the driving of the engine 6, prevents the runway or the like due to an erroneous operation of a vehicle, and a worker knows that the driving stop of the engine 6 is due to the safety arousal mode S operating the warning device k. Thus, the engine 6 can safely be restarted and driven.

Furthermore, the solenoid relay 45 and the warning device k shown in FIG. 6, or the solenoid relay 45, the engine stop relay 50 and the warning device k shown in FIG. 9, which are in the reversal state of presence and absence of the output, are connected to one output port P (P′) in the controller 32. Thus, it is possible to prevent that the configuration of the circuit having the respective independent output ports is complicated like the related art, the circuit configuration can be simplified, and the burden applied to the controller 32 can be reduced.

In other words, by installing the respective relays 47, 45, and 50 having the respective transfer contacts T1, T2, and T3 as mentioned above at the outside of the controller 32, the control of driving and the stop of the engine 6 and the control of the operation presence or absence of the warning device k can be controlled only by one output port P in the controller 32. Thus, when the number of output port if the controller 32 is limited, the electric current value required for the circuit controlling the driving and the stop of the engine 6 is increased, and even when the contact of a high capacity cannot be placed in the controller 32, it is possible to achieve the effect mentioned above by a minimum device connection to the controller 32.

Next, a configuration can be provided which operates the warning device k without starting the engine 6 by the safety arousal mode S. In this case, as shown in FIG. 10, for example, when a vehicle is in the state of the safety arousal mode S, in which information such as a case where the detection of the shaft neutral switch 34 is OFF (the power transmission state to the driving system), a case where the detection of the rear PTO neutral switch 36 is ON (power transmission state to the PTO shaft), and a case where the detection of the seat switch 37 is OFF (the seating state of the seat 13), is transmitted to the controller 32, even if a worker operates the start switch 14b, the controller 32 does not supply the starter relay 47 with electricity (OFF), and thus, the engine 6 is not started.

Next, the controller 32 blocks the supply of electricity to the solenoid relay 45 (in the case of constituting the engine stop relay 50, the electric current supplying to the engine stop solenoid 46 via the engine stop relay 50 is blocked) due to the operating of the start switch 14b, thereby stopping (OFF) the electric current supplying to the engine stop solenoid 46, and operating the warning device k.

Through such a configuration, the warning device k notifies a worker that the engine 6 is not started and driven by the safety arousal mode S when starting the engine 6 in the vehicle, whereby the safety confirmation can reliably be performed before starting the engine 6. Furthermore, owing to the notification of the safety arousal when starting the engine 6, there is no need to install a separate device, and the circuit configuration can be simplified by combining the warning device k.

Furthermore, it is possible to distinguish the notification by the warning device k when starting the engine 6 in the safety arousal mode S mentioned above and the notification by the warning device k when stopping the engine 6 due to the safety arousal mode S in the course of driving the engine 6.

As shown in FIG. 11, in this case, for example, even if a worker operates the start switch 14b in the state of the safety arousal mode S mentioned above, the controller 32 starts the engine 6 without supplying the starter relay 47 with electricity (OFF), and turns the electric current supplying to the engine stop solenoid 46 via the solenoid relay 45 (and the engine stop relay 50) ON/OFF at predetermined time intervals, thereby turning the output of the warning device k OFF/ON by at the timing opposite to the timing of ON/OFF of the output to the engine stop solenoid 46.

Thus, the warning buzzer of the warning device k notifies a worker of the safety arousal mode S when starting the engine 6 by the buzzer sound which is intermittently output at predetermined time intervals. In addition, the output of the buzzer sound in the warning device k is not limited to the predetermined same time interval as mentioned above, and the output (ON) time of the buzzer sound may be longer or shorter than the stop (OFF) time of the buzzer sound. Furthermore, the warning device k may be a warning voice, a warning lamp or the like without being limited to the buzzer sound.

Through such a configuration, by distinguishing the output method of the warning device k between the notification of the safety arousal mode S state to be applied when starting the engine 6 and the notification of the safety arousal mode S state to be applied when stopping the driving of the engine 6 due to the safety arousal mode S in the course of driving the engine 6, a worker can simply and reliably understand the safety arousal mode S state, and an operation to be required later is easily discriminated, whereby the productivity can be improved.

Next, it is possible to comfortably output the warning device k for notifying the safety arousal mode S state when starting the engine 6 and when stopping the driving mentioned above to a worker. In this case, as shown in FIG. 12, for example, when starting or driving the engine 6, in a case where a worker leaves the seat 13 for a second or more, if the seat switch 37 enters the safety arousal mode S state due to the non-detection (OFF) of the seating of a worker, the controller 32 blocks the electric current supplying to the engine stop solenoid 46 via the solenoid relay 45 (and the engine stop relay 50), and operates the warning device k.

Next, after the operation of the warning device k, when the safety arousal mode S state is released, for example, when the seat switch 37 detects the seating of a worker, the controller 32 operates the warning device k by a preset predetermined time, then, resumes the electric current supplying to the engine stop solenoid 46 via the solenoid relay 45 (and the engine stop relay 50), and stops the operation of the warning device k.

Through such a configuration, when a vehicle enters the state of the safety arousal mode S and a worker releases the safety arousal mode S state, the controller 32 operates the warning device k by a predetermined time, and then stops the operation of the warning device k. Thus, unnecessary discomfort is not applied to a worker by the notification of an extended time by the warning device k, and it is possible to suppress the electric power consumption for operating the warning device k. In addition, the operation time of the warning device k is preset, and the setting time thereof is variable.

In addition, even if a vehicle is in the state of the safety arousal mode S, in a model in which the controller 32 does not need to control the driving or the stop of the engine 6, as shown in FIG. 13, the warning device k is connected to the controller 32, and the holding section 46b of the engine stop solenoid 46 is connected to the downstream of the key switch 14.

Through such a configuration, for example, when a worker leaves the seat 13 in a vehicle not including the mid PTO shaft or the like, the controller 32 continuously supplies electric current to the holding section 46b of the engine stop solenoid 46, operates the warning device k while driving the engine 6, and can notify a worker of the state of the safety arousal modes. Accordingly, even in a model not having the control function of the driving and the stop of the engine 6, the engine control device 31c of the present invention can constitute the circuit by sharing the controller 32.

In the engine control device of the present invention, by equipping the power relay in the controller, the circuit configuration of the engine control device can further be simplified. FIG. 14 is an electric circuit diagram of the engine control device including the controller equipped with the power relay.

As shown in FIG. 14, the engine control device 31d equips the glow relay and the solenoid relay mentioned above in the controller 32′. Thus, the glow plug 44 and the engine stop solenoid 46 are connected to the glow relay 43′ and the solenoid relay 45′ in the controller 32′.

Through such a configuration, the whole configuration of the circuit of the engine control device 31d is simplified, without connecting and placing the power relay at the outside of the controller 32′, and the maintenance property is improved. In addition, the engine control device 31d can include the check mechanism K and the warning device k mentioned above.

1. An engine control device for a working vehicle in which a start switch performing a starting operation of an engine and a starter relay supplying electric current to a starting solenoid driving a starting motor for starting an engine in connection with the start switch are connected to a controller, and the controller supplies the starter relay with electricity by outputting an engine starting instruction to the starter relay by the operation of the start switch, to supply the start-up solenoid with electric current, and drives the engine along with the rotation of the starting motor, wherein
the engine control device includes a check mechanism of the starting motor which stops the supply of electricity to the starter relay depending on an electricity supplying time of the starter relay.

2. The engine control device for the working vehicle according to claim 1, wherein the check mechanism is built in the controller, and the controller performs switching of electricity supplying turn on and off to the starter relay at a freely variable predetermined time or time interval.

3. The engine control device for the working vehicle according to claim 1, wherein a glow relay supplying the electric current to a glow plug as a preheating device used for the engine ignition is connected to the controller.

4. The engine control device for the working vehicle according to claim 1, wherein a solenoid relay supplying electric current to an engine stop solenoid further driving or stopping the engine, a shift detector detecting a shift position of a running system power transmission member, a PTO detector detecting a power transmission situation to a PTO shaft driving a working machine, and a seat detector detecting a seating situation of a worker to a seat installed in a vehicle steering section are also connected to the controller, and
output to the engine stop solenoid and a safety mechanism including a warning device are connected to one output port of the controller.

5. The engine control device for the working vehicle according to claim 1, wherein, when a safety arousal mode is obtained in which one or more of the detection information of a power non-transmission to the driving system by the shift detector, the power non-transmission to the PTO shaft by the PTO detector, and the seat seating of a worker by the seat detector is not attained when driving the engine, the controller stops the supply of electricity to the solenoid relay, stops the electric current supplying to the engine stop solenoid, and operates the warning device.

6. The engine control device for the working vehicle according to claim 1, wherein, when the safety arousal mode is obtained during engine starting, the controller stops the supply of electricity to the starter relay, checks the start-up of the engine, stops the electric current supplying to the engine stop solenoid, and operates the warning device.

7. The engine control device for the working vehicle according to claim 1, wherein the engine control device includes a transfer contact relay at the outside of the controller.

8. The engine control device for the working vehicle according to claim 1, wherein the controller excites the glow relay and the solenoid relay for a certain time, by the operation of the start switch.

9. The engine control device for the working vehicle according to claim 1, wherein the controller is equipped with the glow relay and the solenoid relay.

10. The engine control device for the working vehicle according to claim 4, wherein, when a safety arousal mode is obtained in which one or more of the detection information of a power non-transmission to the driving system by the shift detector, the power non-transmission to the PTO shaft by the PTO detector, and the seat seating of a worker by the seat detector is not attained when driving the engine, the controller stops the supply of electricity to the solenoid relay, stops the electric current supplying to the engine stop solenoid, and operates the warning device.

11. The engine control device for the working vehicle according to claim 4, wherein, when the safety arousal mode is obtained during engine starting, the controller stops the supply of electricity to the starter relay, checks the start-up of the engine, stops the electric current supplying to the engine stop solenoid, and operates the warning device.

12. The engine control device for the working vehicle according to claim 4, wherein the controller excites the glow relay and the solenoid relay for a certain time, by the operation of the start switch.

13. The engine control device for the working vehicle according to claim 5, wherein the controller excites the glow relay and the solenoid relay for a certain time, by the operation of the start switch.

14. The engine control device for the working vehicle according to claim 4, wherein the controller is equipped with the glow relay and the solenoid relay.

15. The engine control device for the working vehicle according to claim 5, wherein the controller is equipped with the glow relay and the solenoid relay.

16. The engine control device for the working vehicle according to claim 8, wherein the controller is equipped with the glow relay and the solenoid relay.
